(19) United States
(12) Patent Application Publication
(10) Pub. No.: US 2003/0092386 A1
(43) Pub. Date: May 15, 2003

(54) Predictable communication establishment in ad-hoc wireless network

(76) Inventors: Gyorgy Miklos, Budapest (HU); Andras Racz, Budapest (HU)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/039,606

(22) Filed: Oct. 26, 2001

(51) Int. Cl. H04B 5/00

(52) U.S. Cl. 455/41; 455/445

(57) ABSTRACT

A system and method of communicating between nodes in an ad-hoc frequency-hopping based communication infrastructure, such as a Bluetooth system. The scheduling of page scan and inquiry scan periods within a piconet is based on a pseudo-random principle. By using pseudo-random scheduling of the inquiry scan and page scan intervals, the position of each interval can be easily predicted in advance. Periodic windows are predefined for a communicating node pair. Each of the periodic windows include a time point, i.e., slot, the location of which changes in a pseudo-random manner in consecutive periodic windows.

### BACKGROUND

The present invention is related to ad-hoc wireless network communication, and more particularly to an efficient procedure for establishing and maintaining general connectivity among nodes in an ad-hoc wireless network.

Recently, a radio interface referred to as Bluetooth was introduced to provide wireless, ad-hoc connectivity between mobile phones, laptop computers, headsets, PDAs, and other electronic devices. Some of the implementation details of Bluetooth are disclosed in this application, while an introduction to the Bluetooth system can be found in “BLUETOOTH—The universal radio interface for ad-hoc, wireless connectivity,” by J. C. Haartsen, Ericsson Review No. 3, 1998. Further information about the Bluetooth interface is available in the Bluetooth Specification found on the Official Bluetooth Website on the World Wide Web at http://www.bluetooth.com.

Bluetooth was initially developed to eliminate cables between phones, PC-cards, wireless headsets, etc., but has evolved into an ad-hoc wireless network technology intended for both synchronous traffic, such as voice based traffic, and asynchronous traffic, such as IP based data traffic. Bluetooth promises to provide the ability for any commodity device, such as telephones, PDAs, laptop computers, digital cameras, video monitors, printers, fax machines, to be able to communicate via a radio interface. The commodity devices must contain a Bluetooth radio chip and associated software.

Bluetooth operates in the unlicensed 2.4 GHz ISM (Industrial, Scientific, and Medical) band using a frequency-hopping scheme to minimize interference with non-Bluetooth sources. The frequency-hopping occurs nominally at 1,600 hops per second. The system has 79 possible channels, with a channel spacing of 1 MHZ. Two or more Bluetooth (BT) units sharing the same channel form a piconet, as illustrated in FIG. 1. Each unit is a node in a piconet that may perform the functions of either a master or slave unit. Within each piconet there is always exactly one master and up to seven active slave units.

Two or more piconets can be interconnected to form a scatternet, as illustrated in FIG. 2. The connection point between the two piconets consists of a unit that is a member of both piconets. A unit can simultaneously be a slave unit member of multiple piconets. However, a unit may only be a master unit in one piconet at a time, but may simultaneously participate as a slave unit in other piconets. A unit may only transmit and receive data in one piconet at a time, so participation in multiple piconets is done on a time division multiplex basis.

The Bluetooth system provides full-duplex transmission built on slotted Time Division Duplex (TDD), where each slot is 0.625 ms long. The time slots are cyclically numbered sequentially using a large cycle of 2²⁷. Master-to-slave transmission always starts in an even-numbered time slot, while slave-to-master transmission always starts in an odd-numbered time slot. An even-numbered master-to-slave time slot and its subsequent odd-numbered slave-to-master time slot together comprise a frame, except when multi-slot packets are used. There is no direct transmission between slave units in a Bluetooth piconet, only between master and slave units.

Communication within a piconet is organized so that the master unit polls each slave unit according to a polling scheme. A slave unit typically transmits after being polled by the master unit, with minor exceptions described below. The slave unit starts its transmission in the slave-to-master time slot immediately following the packet received from the master unit. The master unit may or may not include data in the packet used to poll a slave unit. The only exception to the above principle is that when a slave unit has an established Synchronous Connection Oriented (SCO) link, the slave unit may continue to transmit in the pre-allocated slave-to-master time slot, even if not explicitly polled by the master unit in the preceding master-to-slave time slot.

A globally unique 48 bit IEEE 802 address, called the Bluetooth Device Address (BD_ADDR), is assigned to each unit at the time of manufacture, and it is never changed. In addition, the master unit of a piconet assigns a local Active Member Address (AM_ADDR) to each active unit that is a member of the piconet. The AM_ADDR, which is only three bits long and is assigned and cleared dynamically, is unique only within a single piconet. The master unit uses the AM_ADDR when polling a slave unit in a piconet. However, when the slave unit transmits a packet to the master unit, in response to a packet received from the master unit, the slave unit includes its own AM_ADDR in the packet header, not the master unit's.

When forming or reforming a Bluetooth scatternet, the units use the inquiry and paging procedures to discover and establish a connection with neighboring units. The inquiry procedure enables a unit to discover which units are in range, and what their device addresses are and clocks are. A page procedure is used by the master unit to establish a connection with a slave unit.

FIG. 3 illustrates a state diagram of a unit's link controller. Standby 10 is the default state of the unit. In the page scan 30 substate, a unit listens for its own BD_ADDR for the duration of a scan window. The page scan 30 substate can be entered from the standby 10 state or the connection 90 state. In the Standby 10 state, no connection has been established and the unit can use all the capacity to carry out the page scan 30. Before entering the page scan 30 substate from the connection 90 state, the unit reserves a significant amount of capacity for scanning.

The page 20 substate is used by the master unit (source) to activate and connect to a slave unit (destination), which periodically wakes up in the page scan 30 substate and listens as determined by the page scan hopping sequence. The master unit tries to capture the slave by repeatedly transmitting the slave unit's BD_ADDR in different hop channels. Since the Bluetooth clocks of the master unit and the slave unit are not synchronized, the master unit does not know exactly when the slave unit wakes up and on which hop frequency. Therefore, the master unit transmits a train of identical BD_ADDRs at different hop frequencies, and listens in between the transmit intervals until it receives a response from the slave unit.

The page scan 30 substate uses a slower frequency-hopping sequence and requires the slave to wake up only periodically, while the page 20 substate uses a faster frequency-hopping sequence and the page packets are sent as a continuous train. The page 20 and page scan 30 substates are defined such that the slave and master units are guaranteed to eventually coincide in both time and frequency.

The page 20 substate can be entered from the standby 10 state or the connection 90 state. In the standby 10 state, no connection has been established and the unit can use all the capacity to carry out the page 20. Before entering the page scan 30 substate from the connection 90 state, the unit reserves a significant amount of capacity for scanning.

The Bluetooth Baseband Specification 1.1 (Bluetooth specification) provides three alternative modes for the page scan 30 substate. The R0 mode, which requires continuous scanning, provides the fastest possible connection establishment at the expense of continuous use of the unit's capacity and resources. The two other modes are the R1 mode, which requires a page scan period of 1.28 sec. or less, and the R2 mode, which requires a page scan period of 2.56 sec. or less. Page scan 30 modes R1 and R2 are performed during 11.25 sec. intervals. If the source unit knows when the destination unit is performing a page scan 30, the source could limit paging to those intervals only. However, in practice, according to the Bluetooth specification, the source unit does not know when the destination unit is performing a page scan 30. Consequently, the source unit is required to continuously send page packets until the destination unit is in the page scan 30 substate and is using the same frequency, which may require several seconds. Therefore, the current page procedures are relatively slow.

While in the inquiry 50 substate, a unit is attempting discovery of any neighboring units using an inquiry procedure. Once a neighboring unit is discovered, a connection may be established using the page procedure. The inquiry procedure is similar to the page procedure. A source unit performing an inquiry procedure sends short inquiry packets according to an inquiry hopping pattern. A destination unit is discovered while in the inquiry scan 40 substate, during which the unit wakes up for a short period of time to scan for inquiry packets. The inquiry 50 and inquiry scan 40 substates are defined such that the slave and master units are guaranteed to eventually coincide in both time and frequency. However, the inquiring unit does not know when the inquiry scan is performed. The Bluetooth specification only requires that inquiry scan is performed with a period that is 2.56 sec or less. As a result, the inquiry procedure is also relatively slow, taking several seconds.

The more efficient the inquiry and page procedures are, the faster the neighbor discovery and connection establishment functions can be performed. Additionally, while the inquiry and page procedures are performed, the unit's other tasks are preferably minimally inhibited. That is, the procedures should consume as little as possible of a unit's resources, such as processing time and battery power. These two requirements are, to a certain extent, contradictory, and must be balanced. Smart mechanisms and good trade-offs must be developed to satisfactorily meet both requirements. This is particularly important when the inquiry and page procedures are part of an overall process to establish and maintain connectivity among a number of units (nodes) in the vicinity of each other, for example during the formation and maintenance of a scatternet.

Typically, an idle (i.e., unconnected) unit establishes connectivity with a unit in an existing scatternet that is busy performing various other tasks, such as internally supporting applications and communicating with other units, or even forwarding packets on behalf of other units. These activities are interrupted to perform conventional inquiry/inquiry scan and page/page scan procedures.

U.S. Provisional Application No. 60/246,606 describes one way to improve efficiency by coordinating inquiry and inquiry scan periods within a piconet, the coordination being controlled by the master. Page scan periods are precisely scheduled by giving potential paging units detailed parameter information in the inquiry response message about what time to page and what frequency to use. This solution is unnecessarily complex due to the detailed signaling required to provide the parameter information. It is also difficult to predict the page scan periods in advance, especially when a unit changes the rate of occurrence of the page scan periods. There is also no provision for a simple and efficient way by which a previously discovered unit's presence can be verified.

Accordingly, a procedure is needed for fast, simple, and efficient connectivity establishment between units with minimal disturbance of other unit activities.

### SUMMARY

The present inquiry and page procedures are too inefficient to be acceptable, especially for Bluetooth units that are already connected to a piconet or a scatternet. Too much time and resources are taken away from other tasks, such as communication with other units or forwarding packets on behalf of other units. The inquiry and page procedures must be efficient to enable fast neighbor discovery and connection establishment, while at the same time using as little as possible of the participating units' time and resources. Accordingly, improvements to both the inquiry procedure and the page procedure are addressed herein.

The scheduling of page scan and inquiry scan periods within a piconet based on a pseudo-random principle is described. By using pseudo-random scheduling of the inquiry scan and page scan intervals, the position of each interval can be easily predicted in advance, while maintaining the capability to easily change the rate of occurrence of each interval. In addition, it is a simple solution, since no additional parameters are required.

The present invention addresses these and other concerns. According to one aspect, a method of communicating between a first node and a second node in an ad-hoc frequency-hopping based communication infrastructure includes defining periodic windows for the first and the second nodes, each of the periodic windows including a time point located therein, the time point locations changing in a pseudo-random manner in consecutive periodic windows. The first node initiates, during one or more of the time points, communication with the second node, such as a Bluetooth inquiry or page message. The second node then responds by transmitting a signal to the first node.

According to another aspect, a node arranged to communicate in an ad-hoc frequency-hopping based communication infrastructure includes means that define periodic windows for the node, each of the periodic windows including a time point located therein, the time point locations changing in a pseudo-random manner in consecutive periodic windows. The node also includes means that initiate communication with another node during one or more of the time points and receive a signal from the other node in response.

According to yet another aspect, a computer program product for controlling communication between a first node and a second node in an ad-hoc frequency-hopping based communication infrastructure includes a computer-readable storage medium having computer-readable program code means embodied in the medium. The computer-readable program code means include logic that defines periodic windows for the first and the second nodes, each of the periodic windows including a time point located therein, the time point locations changing in a pseudo-random manner in consecutive periodic windows. The computer-readable program code means also include logic that initiates, via the first node, during one or more of the time points, communication with the second node and that transmits, when the first node communication is detected, a signal from said second node to said first node.

### BRIEF DESCRIPTION OF THE DRAWINGS

The above and other objects, features, and advantages of the present invention will become more apparent in light of the following detailed description in conjunction with the drawings, in which like reference numerals identify similar or identical elements, and in which:

FIG. 1 is a diagram illustrating various piconet configurations;

FIG. 2 is a diagram illustrating a scatternet;

FIG. 3 is a state diagram of a BT unit link controller; and

FIGS. 4-7 depict exemplary embodiments associated with pseudo random time point generation, in accordance with the present invention.

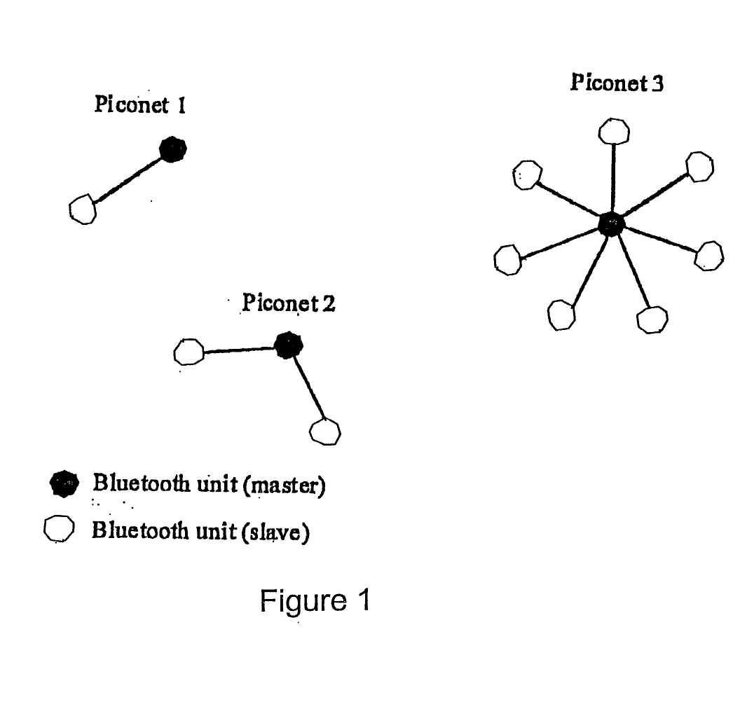

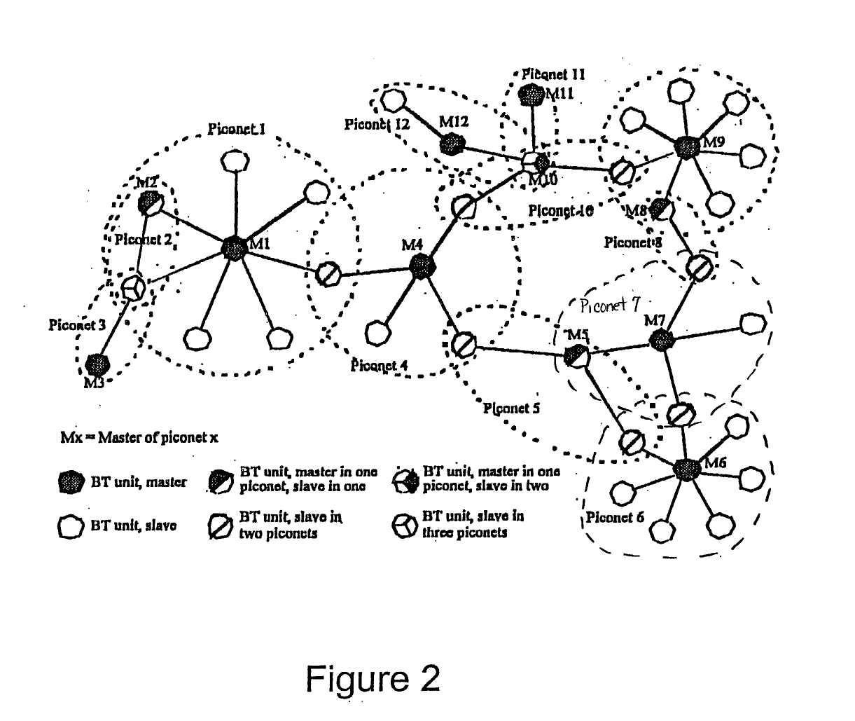

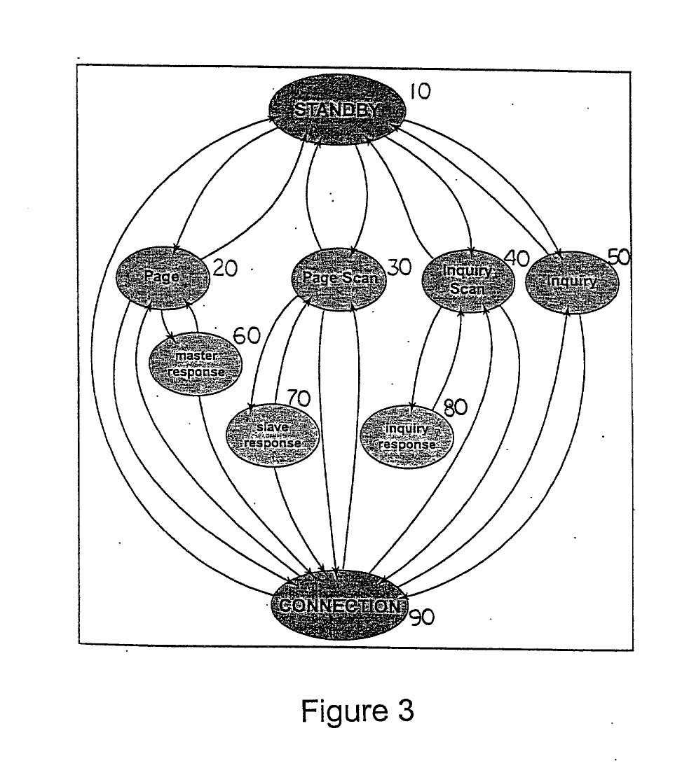

### DETAILED DESCRIPTION

Although, for ease of explanation, the present invention is described herein in terms of the Bluetooth environment, the present invention can be practiced in any frequency-hopping based communication infrastructure.

In accordance with embodiments of the present invention, the coordination between Bluetooth nodes is achieved through the use of pseudo-random scheduling. The principle of this approach is that nodes rely on implicit rules and on previous communication in the past to predict the position of “time points,” i.e., which time slots, when they can transmit signals to each other. The solution does not require the addition of new signaling messages or any modifications to the basic procedures defined in the Bluetooth Baseband specification.

To designate the position of these time points, embodiments of the present invention use a pseudo-random scheme. A periodic window of length T is used and the position of a time point within this window may change from one periodic window to another in a pseudo-random manner.

Inquiry scan and page scan intervals are started at a given time point, thereby providing pseudo-random scheduling of the inquiry scan and page scan intervals. This provides a fast, simple, low overhead procedure for efficient connectivity establishment between units with minimal disturbance of other unit activities. The pseudo-random principle uses successive pseudo-random data, i.e., from a pseudo-random sequence, produced by a fixed calculation process, such as an algorithm.

Pseudo-random scheduling of inquiry scan periods provides a method of monitoring for the presence of neighboring nodes, i.e., units, for which we have previously obtained information. The information previously obtained may be in the form of a special inquiry access code. A special type of inquiry procedure is used that allows an inquired node to respond immediately and only once after the slot when it is inquired.

Each node schedules the beginning of their inquiry scan periods in a pseudo-random fashion. The time points, i.e., which time slots, when each inquiry scan begins are derived from the native clock and address of the node. Each inquiry scan periodic window, T_{IS}, spans multiple time slots and has one such time point. These periodic windows are preferably a power of two multiple slots and are aligned to the bits of the native clock of the node. Time points for a “higher window” are a subset of time points for a “lower window”. For example, a higher window may be longer, having 64 slots, as compared to a lower window having 16 slots. In such a case, the higher window will have a subset of the number of time points in the lower window.

A typical length of the inquiry scan periodic window T_{IS} could be, for example, approximately 64, 256, 1024, or 4096 slots. Using any of the first three values, the Bluetooth specification requirement of at least one inquiry scan every 2.56 seconds is satisfied, since there is at least one inquiry scan period in each interval of 2T_{IS}.

The advantage of using a value from a small subset is that it can be signaled very efficiently (e.g., using only two bits). For example, the value of T_{IS} can be signaled in the inquiry response FHS message by re-defining the bits of the Class of Device field of the FHS packet.

The format of a conventional FHS packet is illustrated in FIG. 4. The Class of Device field, or a portion thereof, for example, is redefined to signal the inquiry scan periodic window length T_{IS}. Since general connectivity is the ultimate goal of the inquiry procedure, it is not very important to know the class of the responding device, so the class of device field is easily omitted. The CLK field is used to transfer the current clock value of the responding unit to the inquiring unit. The various address parts, i.e., Lower (LAP), Upper (UAP), and Nonsignificant (NAP) Address Parts, are used to signal the device address.

Consequently a node that has discovered its neighboring nodes through an inquiry procedure learns the address, clock, and window T_{IS} of all its neighboring nodes. The window T_{IS} can vary from unit to unit, but is preferably a factor of two slots and selected from a small set. The smaller the window is, the faster the discovery procedure is. However, the overhead also increases as T_{IS} decreases.

The future timing and frequency of the inquiry scan periods of the neighboring nodes can be predicted according to the pseudo-random sequence. Accordingly, the reachability of a given neighboring node can be checked very quickly by inquiring at the predicted time and frequency. If the timing accuracy is not perfect, the inquiry can be repeated over a period of time so that it covers the expected inquiry scan with high probability. Even if the clocking accuracy is not perfect, the time to inquire a specific neighbor is reduced to a small number of slots (depending on the timing inaccuracy).

Two or more units may simultaneously inquire a single receiver, causing a collision. When there is no response to an inquiry, a random back-off number of pseudo-random scheduled inquiry scans may be skipped before retrying the page. In one embodiment, BV (back-off value) and CW (contention window) variables are associated with each neighbor being inquired. When the inquiry is successful (an inquiry response is received), CW is set to 1; whereas when the inquiry is unsuccessful, the value of CW doubles, but is limited so that it does not exceed CW_max (one possible value for CW_max is 16). A random BV variable is chosen from the interval [0,CW-1]. At each estimated pseudo-random scan of a neighboring node, the value of BV is decreased by one (if it is positive). An inquiry can be performed when BV is zero. Consequently, if several nodes inquire a neighboring node simultaneously, and the inquiry attempts collide, then they will not continue to collide consistently. Instead, a random number of scan periods is skipped until only one node inquires the neighboring node without a collision.

In addition, when there is no response for a threshold number of inquiry attempts, the assumed value of the window T_{IS} is doubled so that a node which has decreased the rate of the pseudo-random scheduled inquiry scan intervals (increased T_{IS}) can still be inquired. An example value for the inquiry attempt threshold is 4 inquiry attempts. When the estimated T_{IS} is doubled, then CW is halved so that it corresponds to the same amount of time.

This technique differs from the typical random back-off scheme of the inquiry response procedure in the Bluetooth Specification, in which the inquired node responds after a back-off period. In Applicant's technique, an inquired node responds immediately and only once, after the slot when it is inquired. The back-off is performed at the inquiring node. The pseudo-random computation of the frequency and timing ensures that there are no consistent collisions with inquiry responses.

An advantage of being able to check the presence of an already discovered neighbor is that network topology reconfiguration can be made much easier. For example, a node can determine from the inquiry response whether a given neighboring node is still connected to the same scatternet or not by the node's scatternet identity. The scatternet identity concept is described further in copending U.S. application Ser. No. 09/709,643, entitled “Random Identity Management in Scatternet” by Johan Rune, which is hereby incorporated by reference. If the neighboring node has joined a different scatternet, a new connection can be established. This procedure makes it possible to keep a dynamic scatternet together even if some of the links break. While there is still a need to perform a full inquiry to discover new neighboring nodes, there is no need to perform a full inquiry just to check whether an already discovered neighboring node is still present.

In another embodiment, an additional modification may be introduced to the above described special type of inquiry scan so that the inquiry scan does not need to span the required 16 slots, instead the scan can be shorter (as short as a single slot).

Pseudo-random scheduling of page scan procedures provides a method to quickly page a node about which we have previous information from an inquiry response. This procedure could be implemented as a new optional page scan mode.

Just as for the inquiry scan periods, a pseudo-random schedule may be used for the beginning of the page scan periods. A different pseudo-random schedule can be used, which potentially uses a different periodic window size. The page scan periodic window, T_{PS}, can take on values from a larger set, e.g., 32, 64, 128, 256, 512, 1024, 2048, 4096 slots (but would require signaling in three bits). A value of 2048 or lower satisfies the Bluetooth specification requirement for scan repetition R2 (at least one page scan every 2.56 sec.), and a value of 1024 or lower satisfies scan repetition requirement R1 (at least one page scan every 1.28 sec.).

A pseudo-random scheduled page scan preferably takes precedence over a pseudo-random scheduled inquiry scan. Page scans are more important, since they enable connection establishment, while pseudo-random scheduled inquiry scans provide only updated information regarding already discovered neighbors.

Two or more units may simultaneously page a single receiver and cause a collision. This can be solved by using a back-off value as similarly described above for inquiry. Also, if there is no response for a threshold number of times, the assumed value of T_{PS} is doubled so that it becomes possible to contact a receiver that has decreased its rate of page scan periods.

The advantage of using a pseudo-random scheduling of page scan periods is that it allows devices to page a neighbor exactly when it is performing the page scan. Even if the timing is not completely accurate, the paging process can be significantly shortened. The window length T_{PS} may also be signaled in the inquiry response in the Class of Device field, for example, as described above to notify all neighboring nodes. Only three bits are required.

The pseudo-random scheduling of page scans may also be used to replace the pseudo-random scheduling of inquiry scans. In order to update status information about a neighbor, a node pages the neighboring node, exchanges status information, then tears down the connection. This procedure requires higher overhead, but avoids requiring modifications to the inquiry procedure.

In this case, when predictable inquiry is not available, it would be advantageous to introduce a new message type by which a node is able to inform its neighbor about its current clock. This is advantageous because when a predictable page scan is used to make connection establishment faster, the paging device can not update the clock estimate of the node that is being paged. Therefore, a new type of message is needed for updating the clock information to reduce clock drift in the two devices, which would compromise the predictability of the page scan periods. (Note that, in contrast, the inquiry response packet contains the clock information, making the updating of the information clock straightforward.)

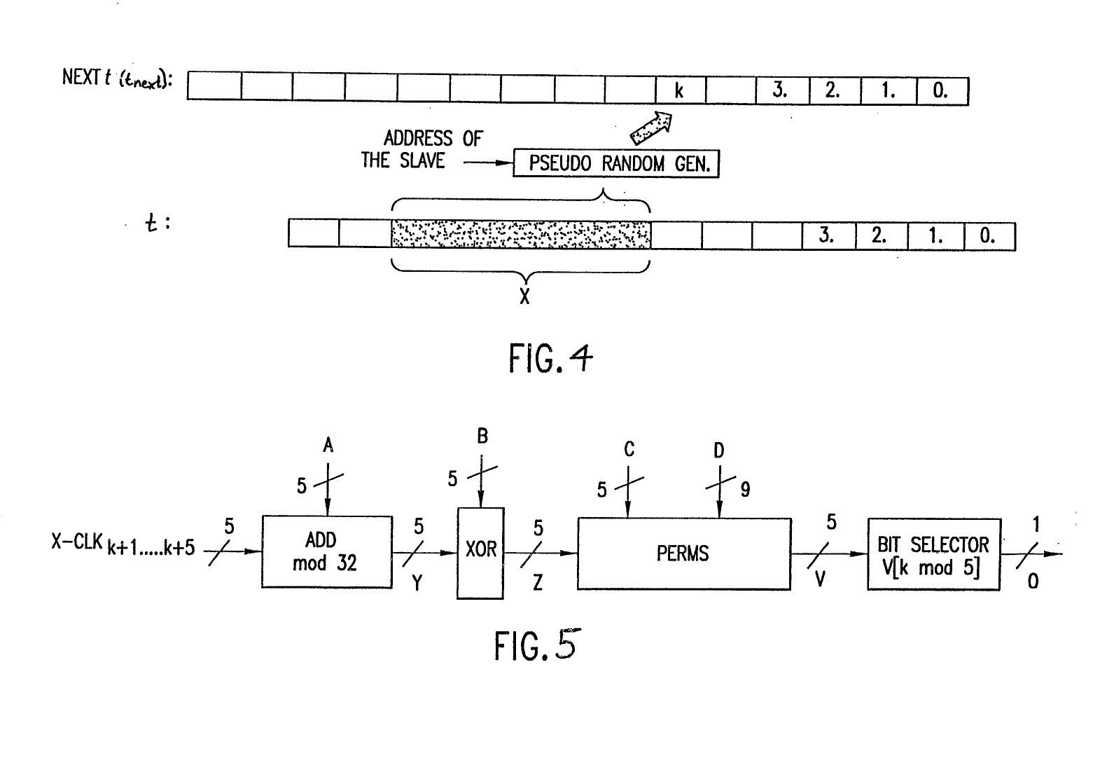

FIGS. 4-7 depict exemplary embodiments associated with generating pseudo-random time points which may be used in accordance with the present invention. In FIG. 4, x represents the bits, k+1 through k+5 of the master clock that serve as an input to the pseudo-random generator when generating the kth bit of the next time point. The bits of the clock at the next time point are generated one by one in a loop using the pseudo-random generator, as depicted in FIG. 5. The Bluetooth clock of the master and the Bluetooth address of the slave are inputs to the pseudo-random generator.

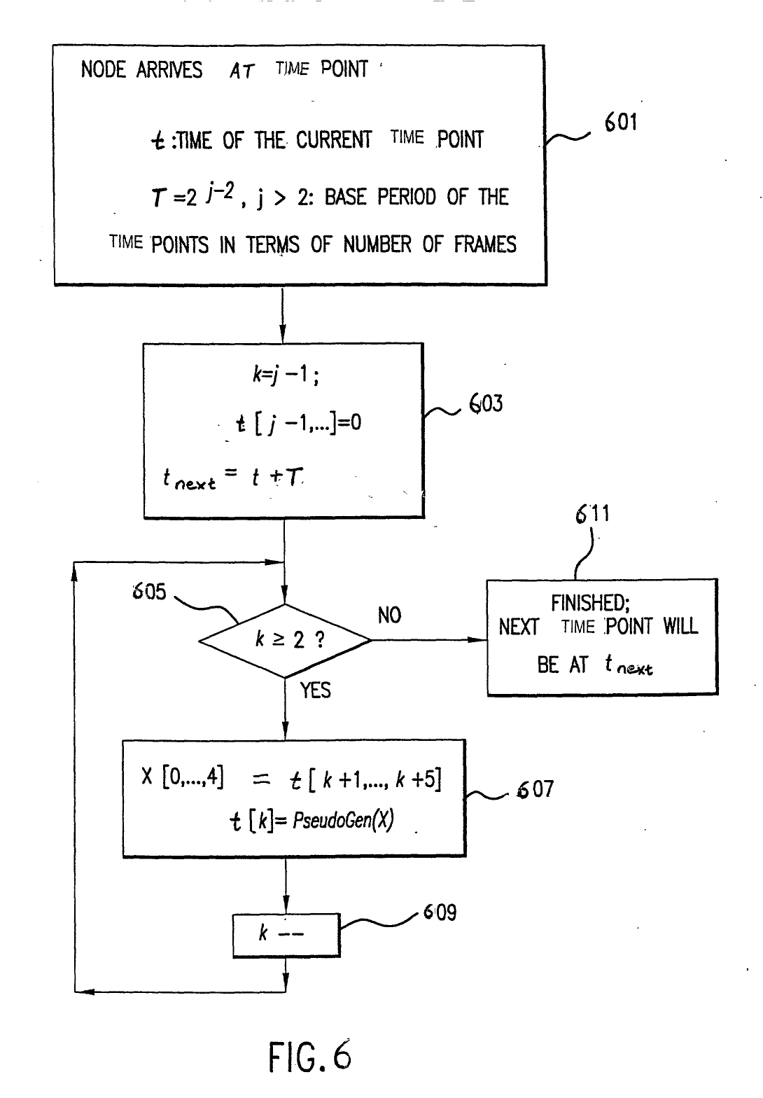

FIG. 6 depicts a flowchart of an exemplary method of developing a pseudo-random sequence for time points. In step 601, upon arriving at a time point t, a node generates the position of the next time point. The variable tₙₑₓₜ stores the master's clock at the time of the next time point. The window length period of the time points is assumed to be T=2^{j-2}, j>2 number of frames. In other words, this means that on average there is one time point in each time interval of length T=2^{j-2} number of frames, and the jth bit of the clock changes at every T.

The method proceeds to step 603 where the position of the next time point tₙₑₓₜ is obtained such that the node adds T to the current t, clears the bits (j−1, . . . 0) and then generates the bits (j−1, . . . 2) one by one using the pseudo-random generator. The method then proceeds to step 605 for a determination of whether k≧2. Upon determining that k is less than two, the method proceeds to step 611 and is completed in accordance with the “no” branch from step 605. If k≧2, the method proceeds to step 607 in accordance with the “yes” branch from step 605. In step 607, when generating the kth bit, j−1≧k≧2, the clock bits t [k+1, . . . ,k+5] are fed as inputs to the pseudo-random generator as illustrated in FIG. 5.

The pseudo-random scheme used in step 607 for selecting the position of the next time point may be derived from the frequency hop selection specified in the Bluetooth specification, in conjunction with embodiments of the present invention. The control words of the pseudo-random generator of an exemplary embodiment of the present invention are listed in Table 1.

TABLE 1
Control Words

| | |
|---|---|
| A | A₂₇₋₂₃ ⊕CLK₂₅₋₂₁ |
| B | B_{0.3} = A₂₂₋₁₉, B₄ = 0 |
| C | A_{8,6,4,2,0}⊕CLK₂₀₋₁₆ |
| D | A₁₈₋₁₀⊕CLK₁₅₋₇ |

These control words, e.g., A, B, C and D, are the same as the control words of the frequency hop selection scheme in the Bluetooth specification. However, the input X and the additional bit selection operator at the end are different. As discussed above, the input X changes depending on which bit of the time point is going to be generated. When generating the kth bit of the time point the clock bits, X=CLK_{k+1 . . . k+5} are used as inputs and the bit selection operator at the end selects the (k mod 5)th bit of the five bits long output V. Upon completing step 607, the method proceeds to step 609 for reduction of the k varible before looping back to step 605 again. In step 605, if it is determined that k is less than two, the method proceeds in accordance with the “no” branch from step 605 to step 611, where the method ends.

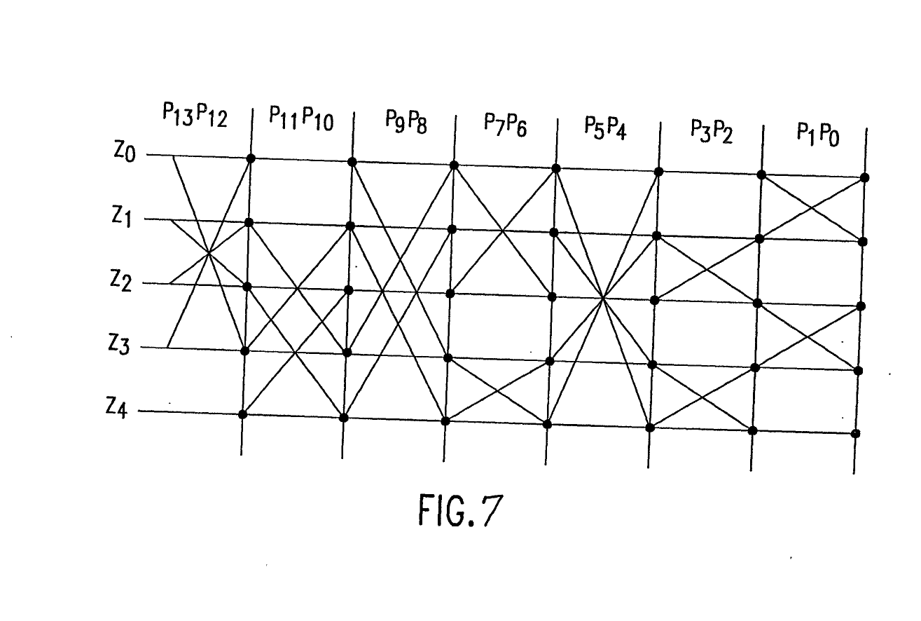

FIG. 7 depicts a butterfly permutation operation PERM5 associated with Table 2 which may be used in conjunction with exemplary embodiments of the present invention. Table 2 may be used in the PERM5 operation of the pseudo-random generator depicted in FIG. 5. For example, the butterfly permutation operation PERM5 of FIG. 7 is the same as in the frequency hop selection scheme of the Bluetooth specification. The table associates each bit of the control word P with a given bit exchange in the input word.

TABLE 2
Control bits and corresponding bit exchanges

| control bit | butterfly | control bit | Butterfly |
|---|---|---|---|
| P₀ | {Z₀,Z₁} | P₇ | {Z₃,Z₄} |
| P₁ | {Z₂,Z₃} | P₈ | {Z₁,Z₄} |
| P₂ | {Z₁,Z₂} | P₉ | {Z₀,Z₃} |
| P₃ | {Z₃,Z₄} | P₁₀ | {Z₂,Z₄} |
| P₄ | {Z₀,Z₄} | P₁₁ | {Z₁,Z₂} |
| P₅ | {Z₁,Z₃} | P₁₂ | {Z₀,Z₃} |
| P₆ | {Z₀,Z₂} | P₁₃ | {Z₁,Z₂} |

If the given bit of the control word is 1, then the corresponding bit exchange is performed, otherwise it is skipped. The control word P is obtained from C and D, such that P_{0 . . . 8}=D_{0 . . . 8} and Pᵢ₊₉=Cᵢ, for i=1 . . . 4.

We have proposed a pseudo-random scheduling of inquiry scan and page scan periods. The pseudo-random scheduling provides a very simple way to make these actions predictable, yet it avoids the potential conflicts with other duties that may arise with periodic scheduling. In addition, it makes signalling very short and simple.

Accordingly, the overhead of scatternet establishment and maintenance, which require frequent inquiry/inquiry scan, page/page scan actions, can be significantly reduced.

It will be appreciated that the steps of the methods illustrated above may be readily implemented either by software that is executed by a suitable processor or by hardware, such as an application-specific integrated circuit (ASIC).

Although described with reference to a communication system, it will be appreciated by those of ordinary skill in the art that this invention can be embodied in other specific forms without departing from its essential character. For example, the invention may be used in any multi-processor system. The embodiments described above should therefore be considered in all respects to be illustrative and not restrictive.

The various aspects of the invention have been described in connection with a number of exemplary embodiments. To facilitate an understanding of the invention, many aspects of the invention were described in terms of sequences of actions that may be performed by elements of a computer system. For example, it will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A method of communicating between a first node and a second node in an ad-hoc communication system, the method comprising the steps of:
defining periodic windows for the first and the second nodes, each of said periodic windows including a time point located therein, said time point locations changing in a pseudo-random manner in consecutive periodic windows; and
initiating, by the first node, during one or more of the time points, communication with the second node.

2. The method of claim 1, comprising the additional step of:
transmitting, when the first node communication is detected, a signal from said second node to said first node.

3. The method of claim 1, wherein the step of defining periodic windows includes previously communicating a periodic window length from the second node to the first node.

4. The method of claim 1, wherein positions of the time points are pseudo-randomly generated according to a node address of the second node.

5. The method of claim 4, wherein positions of the time points are pseudo-randomly generated according additionally to a clock of the second node.

6. The method of claim 1, wherein positions of the time points are pseudo-randomly generated according to a clock of the second node.

7. The method of claim 1, wherein each periodic window is further defined as a power of two multiple slots, one of the slots containing the time point.

8. The method of claim 1, wherein the first node initiates communication with the second node by sending an inquiry message.

9. The method of claim 8, wherein the second node checks at the time point for the inquiry message from the first node by listening for an inquiry message, and upon receiving the inquiry message signals the first node by sending an inquiry response message.

10. The method of claim 1, further comprising steps of:
waiting to send a mesage by the first node until a next time point at which the second node is expected to be present; and
initiating a data transmission from the first node to the second node.

11. The method of claim 1, wherein the frequency-hopping based communication infrastructure is a Bluetooth system.

12. The method of claim 1, wherein when the first node communication is not detected at the second node, the first node skips a random back-off number of pseudo-random time points before retrying the initiation.

13. The method of claim 12, wherein when no response to the first node communication is received at the first node from the second node for a threshold number of attempts, the value of the periodic window is doubled.

14. The method of claim 1, wherein the first node initiates communication with the second node by sending a page message.

15. The method of claim 14, wherein the second node passively checks at the time point for the page message from the first node by listening for a page message, and upon receiving the page message signals the first node by sending a page response message.

16. A node arranged to communicate in an ad-hoc communication system, the node comprising:
means that define periodic windows for the node, each of said periodic windows including a time point located therein, said time point locations changing in a pseudo-random manner in consecutive periodic windows; and
means that initiate during one or more of the time points, communication with another node of the ad-hoc frequency-hopping based communication infrastructure.

17. The node of claim 16, additionally comprising means that receive a signal from said other node.

18. The node of claim 16, wherein positions of the time points are pseudo-randomly generated according to a node address of the other node.

19. The node of claim 18, wherein positions of the time points are pseudo-randomly generated according additionally to a clock of the other node.

20. A computer program product for controlling communication between a first node and a second node in an ad-hoc communication system, the computer program product comprising:
a computer-readable storage medium having computer-readable program code means embodied in said medium, said computer-readable program code means including:
logic that defines periodic windows for the first and the second nodes, each of said periodic windows including a time point located therein, said time point locations changing in a pseudo-random manner in consecutive periodic windows; and
logic that initiates, via the first node, during one or more of the time points, communication with the second node.

21. The computer program product of claim 20, wherein the computer-readable program code means further comprises logic that transmits, when the first node communication is detected, a signal from said second node to said first node.

22. The computer program product of claim 20, wherein positions of the time points are pseudo-randomly generated according to a node address of the second node.

23. The computer program product of claim 22, wherein positions of the time points are pseudo-randomly generated according additionally to a clock of the second node.
